(19) United States
(12) Patent Application Publication
(10) Pub. No.: US 2006/0232833 A1
(43) Pub. Date: Oct. 19, 2006

(54) AUTOMATIC SCANNING APPARATUS AND A METHOD

(76) Inventor: Yang-moon KIM, Yongin-si (KR)

Correspondence Address: STANZIONE & KIM, LLP, 919 18TH STREET, N.W., SUITE 440, WASHINGTON, DC, 20006, US

(21) Appl. No.: 11/379,137

(22) Filed: Apr. 18, 2006

(30) Foreign Application Priority Data
Apr. 19, 2005 (KR) 2005-32319

(51) Int. Cl. H04N 1/04

(52) U.S. Cl. 358/474

(57) ABSTRACT

An automatic scanning method includes automatically setting up a compression mode or a non-compression mode according to a given resolution of a document for scanning, thereby reducing scanning time.

### CROSS-REFERENCE TO RELATED APPLICATIONS

This application claims priority under 35 U.S.C. § 119 from Korean Patent Application No. 2005-32319, filed on Apr. 19, 2005, in the Korean Intellectual Property the entire contents of which are hereby incorporated by reference.

### BACKGROUND OF THE INVENTION

1. Field of the Invention

The present general inventive concept relates to a scanner, and more specifically, to a method of reducing scanning time according to the resolution of an input image.

2. Description of the Related Art

In general, a printing machine, such as a scanner, a printer/fax combo, a scanner/copier combo, etc., is connected to a host device for operation. In scanning an image, a host computer (hereinafter, it is referred to as a host device) generates scan information depending on a resolution set by a user, whether data is compressed, etc., and transfers the data to the printing machine. Therefore, the user is able to set a desired resolution or to select whether to compress data by modifying registration information of the host device.

In order to change the resolution or current status of data compression, the user needs to execute a registration information modification program in the host device, and then can select a desired resolution and whether to compress data, etc., when a dialogue window pops up on a monitor of the host device. Then, the resolution and status of data compression selected by the user are saved as the scan information, and the scan information is transferred to the printing machine to scan data. This scanned data is decompressed for image processing, and the image processed data is either compressed again or remains decompressed during the transmission to tan external device.

In detail, the resolution is set by the user depending on a type of a document to be scanned and whether data is compressed, and the document is scanned based on the set resolution. Generally, a document to be scanned is categorized as a text type and a photo type. Therefore, the user chooses and inputs the type of the document for scanning in advance, or samples part of the document for scanning and sets a scan mode to an automatic mode.

Even though the user also determines whether to compress data, the actual compression time varies depending on the resolution. That is, the size of an original document is determined by the resolution, and the actual scanning time, which includes the amount of time for compressing, transmitting, and decompressing the original document, varies depending on the resolution.

### SUMMARY OF THE INVENTION

The present general inventive concept provides an automatic scanning method and apparatus capable of automatically determining whether or not a document for scanning is compressed, based on the resolution of an input image.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an automatic scanning method of a scanner to scan a document based on a resolution, the method including selecting the resolution, setting a first compression mode based on the selected resolution, and scanning the document according to the selected resolution and the set first compression mode.

The first compression mode may include a non-compression mode. The setting of the first compression mode may include automatically setting a compression mode or a non-compression mode as the first compression mode according to the selected resolution.

The selecting of the resolution may include scanning a document and generating sampling data corresponding to the scanned document, based on the sampling data, determining whether the document contains text data or image data; and automatically selecting the resolution according to the determination of whether the document contains the text data or the image data.

The setting of the first compression mode may include automatically setting the compression mode as the first compression mode if the selected resolution is a predetermined resolution. The setting of the first compression mode may include automatically setting the non-compression mode as the first compression mode if the selected resolution is a resolution different from a predetermined resolution.

The setting of the first compression mode may include scanning the document in the compression mode and the non-compression mode based on the selected resolution, calculating a first total scanning time in one of the compression mode and the non-compression mode, calculating a second total scanning time the other one of the compression mode and the non-compression mode, comparing the first and second total scanning times, and setting the first compression mode to the compression mode or to the non-compression mode based on the lesser of the first and second total scanning times.

The foregoing and/or other aspects and utilities of the present general inventive concept may also be achieved by providing an automatic scanning method useable with an image forming apparatus and a host device to scan a document based on a given resolution, the method including selecting the resolution in the host device, setting a first compression mode based on the selected resolution, transmitting the selected resolution and the set first compression mode to the image forming apparatus, scanning the document according to the transmitted resolution and the set first compression mode to generate scanned data, and transmitting the scanned data to the host device.

The first compression mode may include a non-compression mode. The setting of the first compression mode may include automatically setting a compression mode and the non-compression mode as the first compression mode according to the selected resolution.

The setting of the first compression mode may include automatically setting the compression mode as the first compression mode if the selected resolution is a predetermined resolution. The setting of the first compression mode may include automatically setting the non-compression mode as the first compression mode if the selected resolution is a resolution different from a predetermined resolution.

The setting of the first compression mode may include scanning the document in the compression mode and in the non-compression mode, respectively, based on the selected resolution, calculating a first total scanning time in one of the compression mode and the non-compression mode, calculating a second total scanning time the other one of the compression mode and the non-compression mode, comparing the first and second total scanning times, and setting the first compression mode to the compression mode or to the non-compression mode based on the lesser of the first and second total scanning times.

The foregoing and/or other aspects and utilities of the present general inventive concept may also be achieved by providing a scanning system, including a host device to transmit scan information corresponding to a document to be scanned, and an image forming apparatus to receive the scan information and to scan the document in a first compression mode based on selected resolution.

The first compression mode may include a non-compression mode. The first compression mode may be set to be a compression mode if the selected resolution is a predetermined resolution. The first compression mode may be set to be the non-compression mode if the selected resolution is a resolution different from a predetermined resolution.

The host device may generate sampling data by scanning the document, determine whether the document is text data or image data according to the sampling data, and select a resolution as the selected resolution based on the determination.

The host device may control the image forming apparatus to scan the document in the compression mode and in the non-compression mode, respectively, based on the selected resolution, may calculate a first total scanning time based on one of the compression mode and the non-compression mode, may calculate a second total scanning time based on the other one of the compression mode and the non-compression mode, may compare the first and second total scanning times, and may set the first compression mode to the compression mode or to the non-compression mode based on the lesser of the first and second total scanning times.

The scan information may include at least one of resolution information and compression mode information.

The foregoing and/or other aspects and utilities of the present general inventive concept may also be achieved by providing an automatic scanning apparatus to scan a document based on a selected resolution, the apparatus including an input unit to select the resolution and to set a first compression mode based on the selected resolution, a scanning device, and a controller to control the scanning device to scan the document according to the set first compression mode.

The first compression mode may include a non-compression mode. If the selected resolution is selected through the input unit, a compression mode and a non-compression mode may be automatically set as the first compression mode according to the selected resolution.

The compression mode may be automatically set up as the first compression mode if the selected resolution selected through the input unit is a predetermined resolution. The non-compression mode may be automatically set up as the first compression mode if the resolution selected through the input unit is a resolution different from a predetermined resolution.

The scanning apparatus may be a scanner or a multi function printer with a scanning function.

The foregoing and/or other aspects and utilities of the present general inventive concept may also be achieved by providing an automatic document scanning method, including automatically setting a compression mode or a non-compression mode based on a selected resolution, and scanning the document according to the selected resolution and the set mode.

The foregoing and/or other aspects and utilities of the present general inventive concept may also be achieved by providing a scanning system, including a host device to receive a selected resolution, a controller to automatically set a compression mode or a non-compression mode based on the selected resolution, and a scanning unit to scan a document according to the selected resolution and the set mode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram illustrating a scanner controlled by a host computer according to an embodiment of the present general inventive concept;

FIG. 2 is a flow chart illustrating an automatic scanning method according to an embodiment of the present general inventive concept;

FIG. 3 is a flow chart illustrating a mode set-up procedure based on resolutions according to an embodiment of the present general inventive concept; and

FIG. 4 is a schematic block diagram illustrating a multi function printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Table 1 below illustrates different document sizes based on different resolutions. When the resolution is low (<100 dpi), medium (100-600 dpi), high (600-2400 dpi), and super (≧2400 dpi), the size of the corresponding document is 2.8 MB, 100 MB, 1.56 GB, and 6.2 GB, respectively. The size is computed on the basis of A4 (scan area) True Color (24 bits/pixel).

In addition, a relation between data processing time (i.e., data compression or decompression time) and size was compared. At low (<100 dpi), high (600-2400 dpi), and super (≧2400 dpi) resolutions, non-compressed data was scanned relatively faster as compared to compressed data at the same resolution, whereas at first resolution (100-600 dpi) compressed data was scanned faster than non-compressed data at this resolution.

TABLE 1

| | | Non- | | |
|---|---|---|---|---|
| Resolution | Compression | compression | Size | |
| Low resolution | Slow | Fast | 2.8 | MB |
| (<100 dpi) | | | | |
| Mid resolution (100-600 dpi) | Fast | Slow | 100 | MB |
| High resolution | Slow | Fast | 1.56 | GB |
| (600-2400 dpi) | | | | |
| Super resolution | Slow | Fast | 6.2 | GB |
| (≧2400 dpi) | | | | |

That is, if data of a first resolution is compressed, it can be processed relatively faster than if the data of the first resolution was not compressed. However, at other resolutions, processing efficiency of a compressed data is lower than that of a non-compressed data.

This is because a scanner with a low resolution takes more time to compress data than to directly transmit non-compressed data without performing a compression operation. Moreover, in a case of a scanner with a high resolution, although data is quickly compressed and transmitted, a total amount of time to compress and decompress the data is much greater than a total amount of time to transmit non-compressed data. For example, the amount of time required for compressing 6.2 GB of data at a super resolution (i.e., 4800 dpi) is approximately 2 hours.

Accordingly, if a scanning process is performed based on a data compression status according to a resolution, scanning time can be reduced.

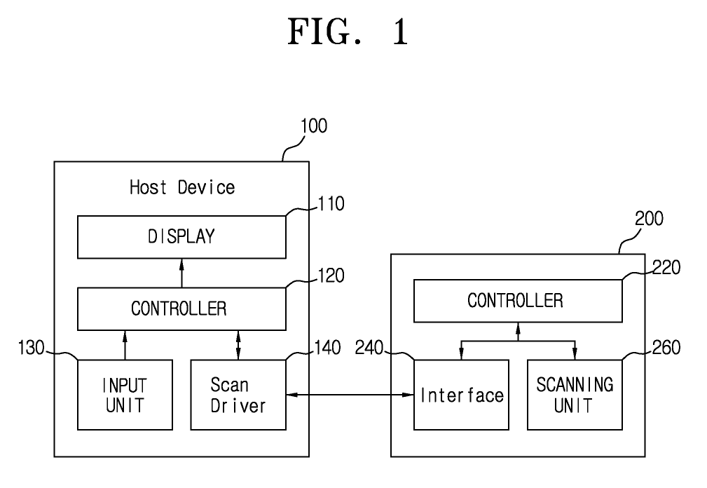

FIG. 1 is a schematic block diagram illustrating a printing machine controlled by a host device according to an embodiment of the present general inventive concept.

A host device 100 can control a printing machine or image forming apparatus 200 (such as a scanner or a multi function printer) with a scanning device having a scanning function to perform a scanning process at a predetermined resolution. The host device 100 can include a display 110, a controller 120, an input unit 130, and a scan driver 140.

The input unit 130 can include a keyboard or a mouse (not illustrated), enabling a user to select a scan mode and a data compression status. The display 110 displays UI (User Interface), enabling a user to set an operation mode of the host device 100 and the scan driver 140.

The controller 120 controls the overall operation of the host device 100. In detail, when the scan mode is selected through the input unit 130, the controller 120 loads the scan driver 140 so that the scan information can be set up through the display 110, thereby enabling the user to set a resolution of data for scanning and the data compression status, and transmits the data to the printing machine 200 where an original document can be scanned.

Upon receiving the scanned image data from the printing machine 200, the controller 120 controls the host device 100 to decompress the compressed data for image processing (e.g., contrast, filter, etc.), and stores the data by compressing it again. A non-compressed data undergoes the image processing and then is stored without being compressed.

The printing machine 200 can include a controller 220, an interface 240, and a scanning unit 260.

The controller 220 controls the overall operation of the printing machine 200 according to a control program stored in an internal ROM.

The interface 240 can be accessible to the host device 100, which is an external equipment, and can function as a communication interface with the host device 100. In other words, the interface 240 can receive the printing data from the host device 100, or can transmit the scanned data from the scanning unit 260 to the host device 100.

According to the scan information, i.e., resolution and data compression status, transmitted under the control of the controller 120, the scanning unit 260 scans a target document, reads an image data, and transmits the image data to the host device 100.

The following now explains an automatic scanning method according to various embodiments of the present general inventive concept.

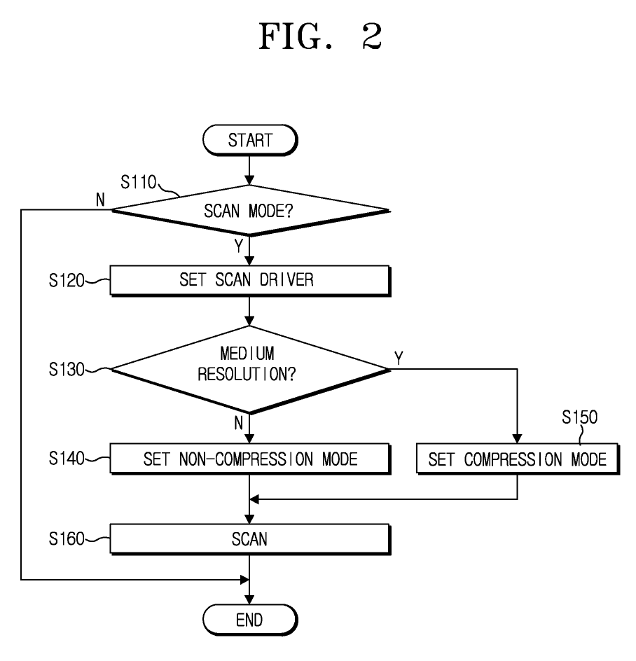

Referring to FIGS. 1 and 2, when a user uses the input unit 130 and selects the scan mode on the UI provided by the display 100 (S110), the controller 120 controls the display 110 to display a UI screen through which the user is able to set a desired scan driver 140 or a desired resolution (S120).

The controller 120 decides whether the scan resolution selected by the user in operation S120 is a predetermined resolution (hereinafter, referred to as ‘predetermined resolution’) (S130). Operation S130 can reduce a scanning time by compressing data only when the selected resolution is the predetermined resolution (e.g., 100-600 dpi, as illustrated in Table 1).

When the selected scan resolution is not the predetermined resolution in operation S130, a non-compression mode automatically selected (S140). When the selected scan resolution is the predetermined resolution in operation S130, a compression mode is automatically selected (S150).

The selected mode in operation S140 or operation S150 is transmitted to the interface 240 of the printing machine 200. Then, the controller 220 operates the scanning unit 260 to scan a document using a conventional scanning method (S160).

The scanned image data is transmitted to the scan driver 140 in form of compressed or non-compressed data, and undergoes image processing (e.g., contrast, filter, etc.).

Therefore, the host device 100 is controlled such that non-compressed data is image processed as it is, whereas compressed data is decompressed first and then goes through image processing. This processed image data can be compressed again to be stored, or can be transmitted to an application as it is (i.e., in a non-compressed state).

Although the compression mode and the non-compression mode can be selected based on the user-selected resolution itself, they can also be selected based on compression ratios. For example, when the compression ratio has a certain value, the compression mode can be automatically selected. On the other hand, when the compression ratio is set to “0”, the non-compression mode can be automatically selected.

The following now explains an automatic scanning apparatus according to another embodiment of the present general inventive concept.

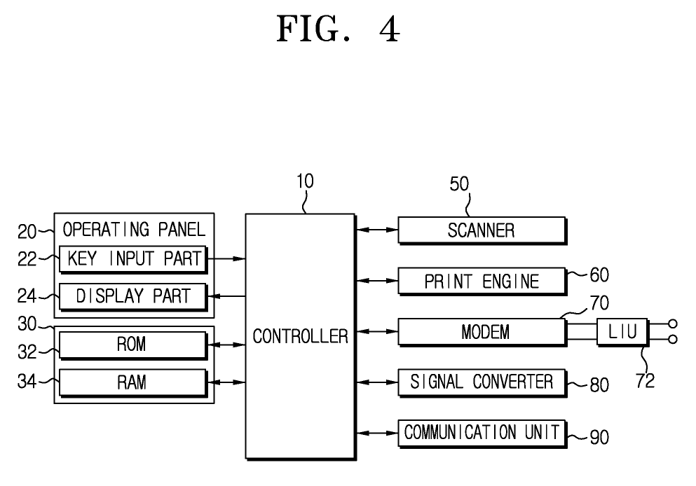

FIG. 4 is a schematic block diagram illustrating a multi function printer with a scanning function. The multi function printer may include an operating panel 20, a memory 30, a scanner 50 to scan a target document, a print engine 60 to print the target document, a modem 70 useable as a first communication module to transmit and/or to receive fax data, a line interface unit (LIU) 72, a signal converter 80, a communication unit 90 useable as a second communication module to transmit and/or to receive emails, and a controller 10.

The operating panel 20 can include a key input part 22 provided with a mode select key (not illustrated) to enable the user to select a scan mode or a data compression status, and a display 24 to display an operational state and UI to allow the user to set the scan driver.

The memory 30 can be composed of ROM 32 and RAM 34.

The ROM 32 is a non-volatile memory device, and stores control programs required to execute every function supported by the multi function printer, firmware to convert scanned data in the scanner 50 into digital data, data transmission protocol, etc. Also, the ROM 32 stores UI to allow the user to set up a desired scanning resolution, and to set a compression and/or non-compression mode when the user selects the scan mode.

The RAM 34 is a volatile memory device, and stores data generated from operations of the multi function printer. That is, the RAM 34 temporarily stores scan data from the scanner 50, and fax data received from an external communication equipment through the modem 70.

The scanner 50, under the control of the controller 10, can scan a target document in the compression mode or the non-compression mode according to the selected resolution, and can read image data.

The image data read by the scanner 50 can be converted to digital data, and can either be stored in the RAM 34 temporarily or printed by the print engine 60. Also, the image data can be transmitted to an external communication equipment through the modem 70 or the communication unit 90.

The print engine 60 prints data to be printed under the control of the controller 10. The data to be printed can include image data read by the scanner 50, fax data received from an external communication equipment through the modem 70, and mail data received through the communication unit 90.

The modem 70, under the control of the controller 10, modulates fax data to be transmitted to an external fax machine (not illustrated) into analog signals, and outputs the analog signals. Moreover, the modem 70 demodulates analog fax data from an external fax machine into digital fax data, and transmits the digital fax data to the controller 10.

The LIU 72, under the control of the controller 10, can form a speech channel between a communication network (e.g., PSTN) and the modem 70, thereby supporting data communications between the communication network and the modem 70.

The signal converter 80 can convert a digitalized document to an electronic mail based on an e-mail transmission standard.

The communication unit 90 transmits an e-mail that is converted by the signal converter 80 to an external mail server (not illustrated), and can receive an e-mail from the external mail server. The e-mail received through the communication unit 90 can either be stored in the RAM 34 or can be printed by the print engine 60. The communication unit 90 can transmit and/or receive emails based on LAN (Local Area Network) access or PSTN (Public Switched Telephone Network) access.

The controller 10 controls the overall operations of the multi function printer, according to the control programs stored in the ROM 32. Specifically, when the scan function is selected through the key input part 22, the controller 10 reads UI from the ROM 32 to allow the user to set up a desired resolution and a compression and/or non-compression mode. Then, the controller 10 controls the scanner 50 to scan a document according to the user selected resolution and mode, and controls the multi function printer to store the scanned image in the RAM 34.

An automatic scanning method according to an embodiment of the present general inventive concept is described as follows.

Referring to FIGS. 2 and 4, when a user selects scan mode on the UI displayed on the display 24 using the key input part 22 (S110), the controller 10 controls the display 24 to display a UI screen stored in the ROM 32 to allow the user to select a desired resolution (S120).

Then, the controller 10 decides whether the user selected a predetermined resolution in operation S120 (S130). Operation S130 reduces a scanning time by performing data compression only for the predetermined resolution (e.g., 100-600 dpi, as illustrated in the Table 1).

Meanwhile, if the user selected a resolution other than the predetermined resolution in operation S130, the non-compression mode is automatically set up (S140). If the predetermined resolution is selected by the user, the compression mode is automatically set up (S150).

According to the automatically selected mode in operation S140 or in operation S150, the controller 10 drives the scanner 50 to scan a target document (S160).

Subsequently, image data scanned by a conventional scanning method are decompressed for image processing (e.g., contrast, filter, etc.), and the controller 10 controls the multi function printer to execute the image processing. The data can either be compressed again for transmission, or can remain as non-compressed data, and are transmitted to an application.

Although the predetermined resolution is described above with reference to the mid resolution (100-600 dpi) illustrated in Table 1, the present general inventive concept is not so limited. That is, the predetermined can be measured differently according to, for example, the performance of the printing equipment 200.

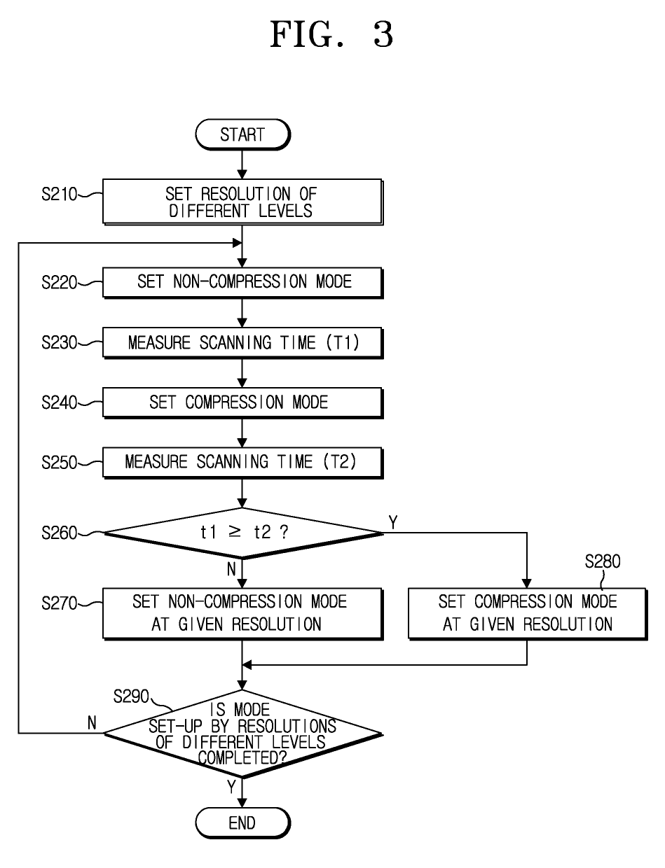

FIG. 3 is a flow chart illustrating a method to set a compression mode and a non-compression mode based on resolutions.

Referring to FIGS. 1 and 3, first, resolutions of predetermined levels according to a function of the printing machine 200 equipped with a scanner function (S210) are set. The resolution can be set to low resolution (<100 dpi), medium resolution (100-600 dpi), high resolution (600-2400 dpi), and super resolution (≧2400 dpi) as described in the Table 1.

A first resolution, for example a low resolution (<100 dpi), is set. The controller 110 sets the scan driver 140 in a non-compression mode (S220), controls the printing equipment 200 to scan a document, and measures a total scanning time t1 (S230). The controller 110 then sets the scan driver 140 in a compression mode (S240), controls the scanner 50 to scan the document again, and measures a total scanning time t2 (S250). The total scanning times t1 and t2 each includes an amount of time for compressing, transmitting, and decompressing data. The total scanning time should, but may not, equal a typical scanning time that the user actually feels after selecting the scan mode.

After measuring the scanning time at the first resolution, e.g., the low resolution, the total scanning time t1 in the non-compression mode is compared with the total scanning time t2 in compression mode (S260). If t1<t2 in operation S260, the non-compression mode is associated with the first resolution such that the non-compression mode is automatically set when the user chooses the corresponding first resolution (S270). Meanwhile, if t1≧t2 in operation S260, the compression mode is associated with the first resolution such that the compression mode is automatically set when the user chooses the corresponding first resolution (S280).

Then, it is determined whether a mode set-up has been completed for each of resolutions of different levels (S290), and if not, the above-described procedure is repeated for each resolution. In this manner, the mode of less scanning time is automatically set for each resolution.

The above-described procedure according to various embodiments of the present general inventive concept may also be achieved by providing an automatic document scanning method, including automatically setting a compression mode or a non-compression mode based on a selected resolution, and scanning the document according to the selected resolution and the set mode.

The method may further include scanning the document to generate sample data, determining whether the sample data is text data or image data, and automatically inputting the selected resolution based on the determination. The method may further include automatically setting the compression mode when the selected resolution is a predetermined resolution, and scanning the document according to the selected resolution and the compression mode. The method may further include automatically setting the non-compression mode when the selected resolution is different from a predetermined resolution, and scanning the document according to the selected resolution and the non-compression mode.

The above-described procedure according to various embodiments of the present general inventive concept may also be achieved by providing a scanning system, including a host device to receive a selected resolution, a controller to automatically set a compression mode or a non-compression mode based on the selected resolution, and a scanning unit to scan a document according to the selected resolution and the set mode.

The above-described procedure according to various embodiments of the present general inventive concept can also be used where a resolution is selected according to a text mode and a photo mode. That is, by dividing the selected resolution into a compression mode and a non-compression mode and executing the above-described procedure, the compression mode and the non-compression mode can be set up automatically according to the text mode and the photo mode.

According to various embodiments of the present general inventive concept, a compression mode and a non-compression mode can be set automatically based on resolutions selected by a user. Even where the user sets up the compression mode and the non-compression mode using an input device, an automatic mode set-up procedure according to various embodiments of the present general inventive concept can be executed to preset a compression and/or non-compression mode based on resolutions. In this way, the user does not need to worry about selecting mode taking a lot of scanning time. For example, when a medium resolution is chosen, the select bar can automatically be positioned in compression mode.

An automatic scanning method according to various embodiments of the present general inventive concept is effective reduce a total scanning time by setting a compression mode and a non-compression mode to correspond to various input resolutions, such then when one of the various input resolutions is selected, the corresponding compression mode or non-compression mode is automatically selected.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An automatic scanning method of a scanner to scan a document based on a given resolution, the method comprising the steps of:
selecting the resolution;
setting a first compression mode based on the selected resolution; and
scanning the document according to the selected resolution and the set first compression mode.

2. The method according to claim 1, wherein the first compression mode comprises a non-compression mode.

3. The method according to claim 1, wherein the setting of the first compression mode includes automatically setting a compression mode or a non-compression mode as the first compression mode according to the selected resolution.

4. The method according to claim 1, wherein the selecting of the resolution includes:
scanning a document and generating sampling data corresponding to the scanned document;
based on the sampling data, determining whether the document contains text data or image data; and
automatically selecting the resolution according to the determination of whether the document contains the text data or the image data.

5. The method according to claim 1, wherein the setting of the first compression mode includes automatically setting a compression mode as the first compression mode if the selected resolution is a predetermined resolution.

6. The method according to claim 1, wherein the setting of the first compression mode includes automatically setting a non-compression mode as the first compression mode if the selected resolution is a resolution different from a predetermined resolution.

7. The method according to claim 1, wherein the setting of the first compression mode comprises:
scanning the document in a compression mode and a non-compression mode based on the selected resolution;
calculating a first total scanning time in one of the compression mode and the non-compression mode;
calculating a second total scanning time the other one of the compression mode and the non-compression mode;
comparing the first and second total scanning times; and
setting the first compression mode to the compression mode or to the non-compression mode based on the lesser of the first and second total scanning times.

8. An automatic scanning method useable with an image forming apparatus and a host device to scan a document based on a resolution, the method comprising:
selecting the resolution in the host device;
setting a first compression mode based on the selected resolution;
transmitting the selected resolution and the set first compression mode to the image forming apparatus;
scanning the document according to the transmitted resolution and the set first compression mode to generate scanned data; and
transmitting the scanned data to the host device.

9. The method according to claim 8, wherein the first compression mode comprises a non-compression mode.

10. The method according to claim 8, wherein the setting of the first compression mode includes automatically setting a compression mode and a non-compression mode as the first compression mode according to the selected resolution.

11. The method according to claim 8, wherein the setting of the first compression mode includes automatically setting a compression mode as the first compression mode if the selected resolution is a predetermined resolution.

12. The method according to claim 11, wherein the setting of the first compression mode includes automatically setting a non-compression mode as the first compression mode if the selected resolution is a resolution different from a predetermined resolution.

13. The method according to claim 8, wherein the setting of the first compression mode includes:
scanning the document in a compression mode and in a non-compression mode, respectively, based on the selected resolution;
calculating a first total scanning time in one of the compression mode and the non-compression mode;
calculating a second total scanning time the other one of the compression mode and the non-compression mode;
comparing the first and second total scanning times; and
setting the first compression mode to the compression mode or to the non-compression mode based on the lesser of the first and second total scanning times.

14. A scanning system, comprising:
a host device to transmit scan information corresponding to a document to be scanned; and
an image forming apparatus to receive the scan information and to scan the document in a first compression mode based on selected resolution.

15. The system according to claim 14, wherein the first compression mode comprises a non-compression mode.

16. The system according to claim 14, wherein the first compression mode is set to be a compression mode if the selected resolution is a predetermined resolution.

17. The system according to claim 14, wherein the first compression mode is set to be a non-compression mode if the selected resolution is a resolution different from the predetermined resolution.

18. The system according to claim 14, wherein the host device:
generates sampling data by scanning the document;
determines whether the document is text data or image data according to the sampling data; and
selects a resolution as the selected resolution based on the determination.

19. The system according to claim 14, wherein the host device:
controls the image forming apparatus to scan the document in a compression mode and in a non-compression mode, respectively, based on the selected resolution,
calculates a first total scanning time based on one of the compression mode and the non-compression mode;
calculates a second total scanning time based on the other one of the compression mode and the non-compression mode;
compares the first and second total scanning times; and
sets the first compression mode to the compression mode or to the non-compression mode based on the lesser of the first and second total scanning times.

20. The system according to claim 14, wherein the scan information comprises at least one of resolution information and compression mode information.

21. An automatic scanning apparatus to scan a document based on a selected resolution, the apparatus comprising:
an input unit to select the resolution and to set a first compression mode based on the selected resolution;
a scanning device; and
a controller to control the scanning device to scan the document according to the set first compression mode.

22. The apparatus according to claim 21, wherein the first compression mode is switched to a non-compression mode if a compression ratio is set to 0.

23. The apparatus according to claim 22, wherein, if the selected resolution is selected through the input unit, a compression mode and the non-compression mode are automatically set as the first compression mode according to the selected resolution.

24. The apparatus according to claim 22, wherein the compression mode is automatically set up as the first compression mode if the selected resolution selected through the input unit is a predetermined resolution.

25. The apparatus according to claim 24, wherein the non-compression mode is automatically set up as the first compression mode if the selected resolution selected through the input unit is a resolution different from the predetermined resolution.

26. The apparatus according to claim 21, wherein the scanning apparatus is a scanner or a multi function printer with a scanning function.

27. An automatic document scanning method, comprising:
automatically setting a compression mode or a non-compression mode based on a selected resolution; and
scanning the document according to the selected resolution and the set mode.

28. A scanning system, comprising:
a host device to receive a selected resolution;
a controller to automatically set a compression mode or a non-compression mode based on the selected resolution; and
a scanning unit to scan a document according to the selected resolution and the set mode.
